(19) United States
(12) Patent Application Publication
(10) Pub. No.: US 2003/0215240 A1
(43) Pub. Date: Nov. 20, 2003

(54) Optical WDM with single mode tolerance and low profile

(76) Inventors: Eric B. Grann, San Ramon, CA (US); Curtis A. Ray, Alamo, CA (US); Scott Fluegal, San Ramon, CA (US)

Correspondence Address: Bruce H. Johnsonbaugh, Eckhoff & Hoppe, Two Transamerica Center, Suite 1700, 505 Sansome Street, SAN FRANCISCO, CA, 94111, US

(21) Appl. No.: 10/395,474

(22) Filed: Mar. 21, 2003

Related U.S. Application Data
(60) Provisional application No. 60/370,108, filed on Apr. 3, 2002.

(51) Int. Cl. H04J 14/02

(52) U.S. Cl. 398/85

(57) ABSTRACT

A low profile, optical WDM is provided having a single mode tolerance. To accomplish the low profile aspect, laser-to-fiber connections are utilized, eliminating most of the fiber-to-fiber connections required by the prior art. Reduction of fiber-to-fiber connections facilitates the downsizing of the device without the risk of breaking fibers. The single mode tolerance is achieved by the use of canned lasers together with a precision optical block. A 4 channel embodiment can be packaged in a module less than 5 mm thick, less than 20 mm wide and less than 25 mm in length.

### CROSS-REFERENCE TO RELATED APPLICATION

This application claims the benefit of and priority from U.S. provisional application Serial No. 60/370,108 filed Apr. 3, 2002.

### BACKGROUND AND BRIEF SUMMARY OF THE INVENTION

The present invention relates generally to an optical wavelength division multiplexer and/or demultiplexer (WDM) having a low profile and a single mode tolerance.

Single mode tolerance WDMs are known in the prior art, as shown for example in U.S. Pat. Nos. 5,583,683 and 5,786,915 to Scobey. The disadvantage of the Scobey design is that “fiber-to-fiber” connections are required for each laser and at the output end of the WDM. For example, to use a Scobey multiplexer design for four separate wavelengths, a total of five fibers are required, four fibers in and one fiber out. The disadvantage in using “fiber-to-fiber” connections is that it is difficult to physically downsize the module. Packing fibers into a small module requires significantly greater cost of assembly and results in broken fibers. Of course, any broken fibers render the WDM useless.

There is a definite demand for smaller optical WDMs which obtain “single mode” tolerance and which are capable of being economically packaged into a low profile module.

The present invention overcomes the difficulties of attempting to downsize a “fiber-to-fiber” design such as Scobey. According to the present invention, “laser-to-fiber” connections are utilized, thereby eliminating most of the fiber connections required by Scobey. For example, the present invention in a preferred embodiment wherein four separate wavelengths are multiplexed will utilize only a single fiber together with four lasers. The design of the present invention eliminates most of the “fiber-to-fiber” connections required by the prior art, as exemplified by Scobey, and allows packaging in a much smaller module. For example, a preferred embodiment of the present invention is capable of packaging a WDM having single mode tolerance with only one single fiber connection into a four channel module less than five mm thick, less than 20 mm wide and less than 25 mm in length.

Furthermore, the present invention significantly simplifies the manufacturing steps necessary to build an optical WDM transmitter or receiver assembly. The invention described by Scobey is a passive device that requires one to couple both the input and output of the WDM assembly to a fiber. Therefore, to create a WDM transmitter or receiver assembly utilizing the invention described by Scobey requires one go through the following steps: align a laser/receiver can to a fiber, align a fiber to an optical coupler, align the optical coupler to the WDM assembly, and then align the output coupler to a fiber. The invention described herein reduces the alignment steps to the following: align a laser/receiver can to the collimating optics, and align the output coupler to a fiber. Since a significant amount of effort is required to align optical systems with single-mode tolerances, the invention described herein can reduce the manufacturing cost by more than half. Additionally, the reduced part count and lack of fiber connections between the laser/receiver and the WDM assembly results in a lower cost of materials and more compact WDM transmitter/receiver package.

A primary object of the present invention is to provide an optical WDM having single mode tolerance and which can be packaged into a relatively small module with fewer fiber-to-fiber connections than known in the prior art.

A further object of the present invention is to provide an optical WDM having single mode tolerance which may be packed into a relatively small module with reduced chance of broken fiber connections as compared with the prior art.

A further object of the present invention is to provide an optical WDM with single mode tolerance and which requires a reduced number of alignments during the assembly process, greatly reducing the overall manufacturing expense.

A further object of the present invention is to provide an optical WDM having single mode tolerance and which utilizes canned lasers to reduce the number of fiber-to-fiber connections in the device.

Further objects and advantages of the invention will become apparent from the following description and the drawings wherein:

### BRIEF DESCRIPTION OF THE DRAWINGS

FIG. 1 is a schematic representation of the invention showing a plan view, partially in section, of a first embodiment of the invention;

FIG. 2 is a perspective view of the embodiment shown in FIG. 1; and

FIG. 3 is a schematic representation of an alternate embodiment of the invention.

### DETAILED DESCRIPTION OF THE DRAWINGS

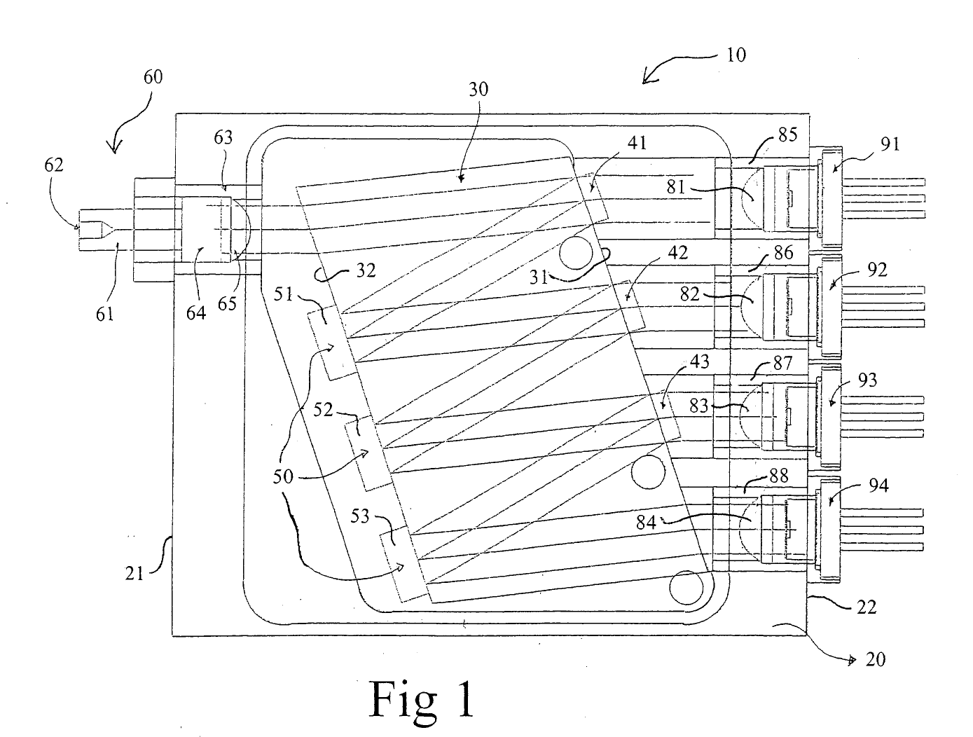

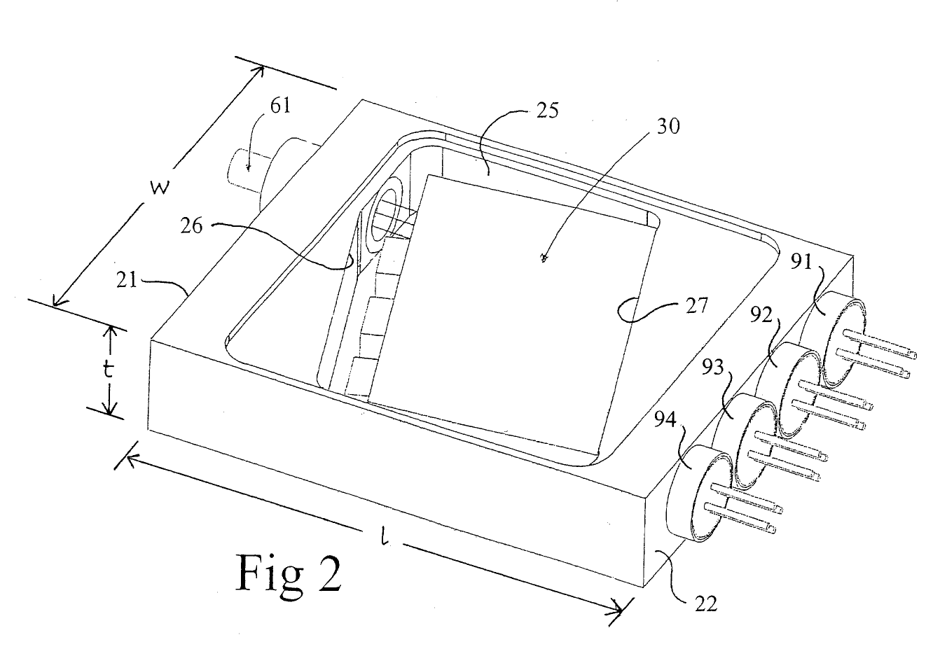

FIGS. 1 and 2 illustrate a first embodiment of the invention. The low profile WDM shown generally as 10 includes a low profile, optically transparent housing 20 having first and second ends 21 and 22, respectively. By “low profile” we mean that the overall thickness “t” of housing 20 is less than 5 mm and the overall width “w” of housing 20 is less than 20 mm. In the embodiment shown in FIGS. 1 and 2, the overall length “I” is less than 25 mm. Housing 20 has a cavity 25 formed therein to receive and carry precision optical block 30. Cavity 25 includes front wall 26 and rear wall 27. Housing 20 is fabricated of glass or plastic which is transparent in the wavelength range for which the device operates.

In the demultiplexer configuration, multi-wavelength light enters the precision optical block 30 through a fiber collimation device shown generally as 60 which includes a fiber optic cable 62, a fiber holding device 61, a fiber collimation holder 63, an optically transparent spacer 64 and a transparent collimating lens 65. The fiber optic holder 61 is carried by the first end 21 of housing 20 and is adapted to support a single mode fiber optic cable 62 in optical alignment with optical block 30 as described in greater detail below. Collimating lens 65 is positioned between fiber optic holder 61 and optical block 30.

In a demultiplexer configuration, light enters the precision optical block 30 from collimating lens 65 and a first filter 41, mounted on first surface 31 of block 30 transmits the desired wavelength and reflects all other wavelengths to reflector 51 carried on the second surface 32 of optical block 30. The multi-wavelength light continues zigzagging down the block until all wavelengths have been separated into their individual wavelength. Once each optical wavelength has been separated, they are each directed to an integrated focusing detector device including focusing lenses 81-84 and detectors 91-94. Focusing lenses 81-84 are supported by holders 85-88, respectively.

In a multiplexing transmitter configuration, the detector packages 91-94 are replaced with multi-wavelength laser packages utilizing canned lasers and the multiplexer 10 combines each wavelength into a multi-wavelength signal that is focused onto single mode optical fibers 62 for transmission.

The precision optical block 30 is constructed of glass, plastic, silicon or other material that is optically transmissive over the desired spectral region.

The reflective surfaces 51, 52 and 53 can be constructed in a number of different ways, to include a direct deposition of either a metallic or dielectric layer to the second surface 32 of optical block 30 or discrete metallic or dielectric reflectors that are attached to second surface 32 of block 30. The layer can be deposited or adhered to block 30 with a number of generally available techniques.

The bandpass filter surfaces 41, 42 and 43 of the optical block 30 are constructed of multiple optical filters adhered in such a manner that they are parallel to the respective reflective surfaces 51, 52 and 53 on the opposite side of the optically transmissive block 30. In a multiplexer configuration, only filters 41, 42 and 43 are required. In a demultiplexer configuration, an additional bandpass filter must be placed between the zigzag block 30 and the detector 94.

It is significant to note that in the multiplexer configuration of FIGS. 1 and 2, a direct “laser to fiber” connection is established between each of the four lasers 91-94 and the single mode optical fiber 62. The present invention allows the elimination of the fiber connections required by the Scobey patents, identified above, between the input lasers and the output fiber. Elimination of these “fiber-to-fiber” connections allows the downsizing of multiplexer 10 and reduces the risk of broken fibers that would otherwise be present with “fiber-to-fiber” connections between the input lasers and the single output fiber. FIGS. 1 and 2 illustrate an embodiment using 4 channels. The invention is applicable to the general case of n channels.

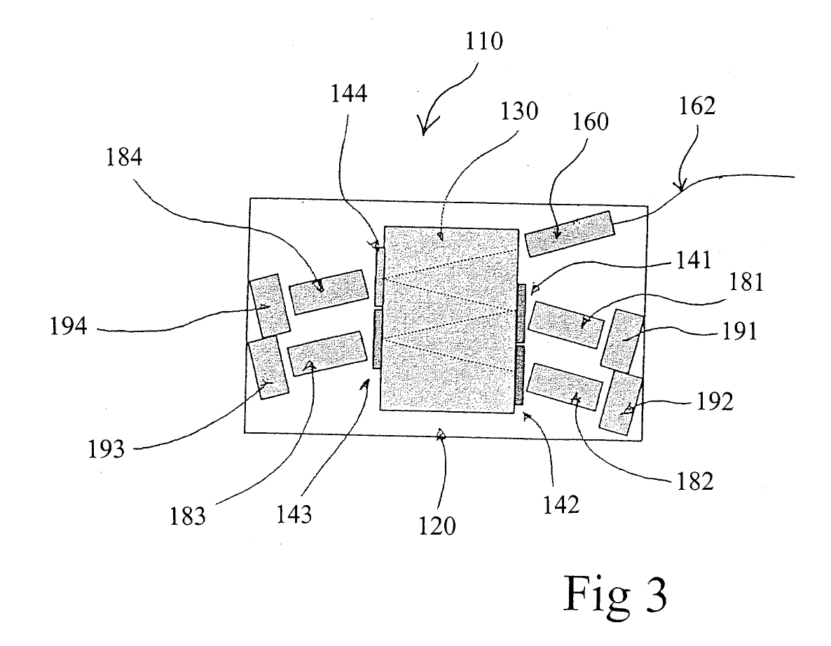

FIG. 3 is a schematic representation of a second embodiment of the invention in which the laser/detector packages 191-194 are placed on opposite sides of the zigzag optical block 130. The embodiment illustrated in FIG. 3 is capable of achieving the low profile aspect of the embodiment shown in FIGS. 1 and 2, as well as the elimination of “fiber-to-fiber” connections between input lasers 191-194 and the output single mode fiber (not shown in FIG. 3 for simplicity). The laser collimators/detector focusers 181-182 can be constructed in a manner similar as in the embodiment shown in FIGS. 1 and 2. The zigzag optical block 130 is constructed of glass, plastic, silicon or any other material that is optically transmissive over the desired spectral region. The bandpass filter surfaces of the optical block 130 are constructed of multiple optical filters adhered in such a manner that the surfaces of filters 141 and 142 are parallel to the surfaces of filters 143 and 144 on the opposite side of optical block 130. In a multiplexer configuration, the filter surface 142 could be replaced with a number of optically transmissive mediums, including air. Optical block 130 is carried by low profile housing 120. A focusing/collimating fiber holder 160 is optically coupled with single mode fiber 162. FIG. 3 illustrates an embodiment with 4 channels, but the invention applies to the general case with n channels. In this embodiment, n is preferably an even integer and n/2 of said canned lasers or photodetectors are positioned on opposite sides of optical block 130.

In some multiplexer configuration cases, it may be required to minimize the reflections returning to the lasers. To minimize the reflections, an isolator can be added to the multiplexer device in various ways. A free-space isolator can be placed between each laser 91-94 and its respective filter. An alternative configuration includes a single free space isolator between the fiber coupler 60 and the output of zigzag reflecting block 30. Another configuration is to place a fiber based isolator after the output filter 12. The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A low profile optical wavelength division multiplexer and demultiplexer for single mode fiber optic communication systems, wherein n channels are transmitted through one single mode fiber optic cable having n different wavelengths, comprising:
a low profile optical block having a flat first surface and a flat second surface, said optical block being optically transparent,
a plurality of n filters carried on said optical block, said filters adapted to separately filter said n different wavelengths,
a plurality of reflective coatings carried by said optical block,
a low profile housing having first and second ends which carries said optical block,
a fiber optic holder carried by said first end of said housing, said holder adapted to support a single mode fiber optic cable in optical alignment with said optical block,
a collimating lens positioned between said fiber optic holder and said optical block,
a plurality of either n canned lasers or n photodetectors carried by said housing, and
means for optically coupling said n canned lasers to said single mode optical fiber without requiring any fiber connection to any of said n canned lasers, and whereby the absence of fiber connectors to said n canned lasers facilitates downsizing the device with reduced risk of broken fibers than would otherwise be present with separate fiber connections to each of said n lasers.

2. The apparatus of claim 1 wherein each of said n canned lasers or n photodetectors are carried by said second end of said housing.

3. The apparatus of claim 1 wherein n is an even integer and wherein n/2 of said canned lasers or photodetectors are positioned on opposite sides of said optical block.

4. The apparatus of claim 1 wherein n equals 4 and said apparatus has an overall thickness less than 5 mm, an overall width less than 20 mm and an overall length less than 25 mm.

5. A low profile optical wavelength division multiplexer and demultiplexer for single mode fiber optic communication systems, wherein n channels are transmitted through one single mode fiber optic cable having n different wavelengths, comprising.
a low profile optical block having a flat first surface and a flat second surface, said optical block being optically transparent,
a plurality of n filters carried on said first surface of said optical block, said filters adapted to separately filter said n different wavelengths,
a reflective coating carried by said second surface of said optical block,
a low profile, optically transparent housing having first and second ends which carries said optical block,
a fiber optic holder carried by said first end of said housing, said holder adapted to support a single mode fiber optic cable in optical alignment with said optical block,
a collimating lens positioned between said fiber optic holder and said optical block,
a plurality of either n canned lasers or n photodetectors carried by said second end of said housing,
said optical block being positioned in said housing angularly to form a zigzag pathway and optically coupling said single mode fiber optic cable with said n canned lasers or n photodetectors, whereby said n canned lasers are optically coupled to said single mode optical fiber without requiring any fiber connection to any of said n canned lasers, and whereby the absence of fiber connectors to said n canned lasers facilitates downsizing the device with reduced risk of broken fibers than would otherwise be present with separate fiber connections to each of said n lasers.

6. The apparatus of claim 5 wherein n equals 4 and said apparatus has an overall thickness less than 5 mm, an overall width less than 20 mm and an overall length less than 25 mm.
